(19) United States
(12) Patent Application Publication
(10) Pub. No.: US 2018/0290772 A1
(43) Pub. Date: Oct. 11, 2018

(54) Automatic Filling System

(71) Applicant: Yung-Hsing Lin, Taichung City (TW)

(72) Inventor: Yung-Hsing Lin, Taichung City (TW)

(21) Appl. No.: 15/944,076

(22) Filed: Apr. 3, 2018

(30) Foreign Application Priority Data
Apr. 11, 2017 (TW) 106204965

(51) Int. Cl. B65B 1/46; B67C 3/20; B67C 3/24; B67C 3/26; B65B 57/00; B67B 1/00

(52) U.S. Cl. CPC B65B 1/46; B67C 3/202; B67B 1/00; B67C 3/26; B65B 57/00; B67C 3/24

(57) ABSTRACT

An automatic filling system is for filling a filling material into a filling container. The automatic filling system includes abase, a transport unit having multiple transport seats disposed along a looped transport route, an input unit for transferring the filling container to one of the transport seats, an inverting unit for inverting the filling container, a fill unit for filling the filling material into the filling container, a stopper placement unit for placement of a stopper, a cap placement unit for placement of a cap, a locking unit for locking the cap, a detecting unit for weight measurement, a defect removing unit, and an output unit for transferring the filling container out of the transport unit.

### CROSS-REFERENCE TO RELATED APPLICATION

This application claims priority of Taiwanese Utility Model Patent Application No. 106204965, filed on Apr. 11, 2017.

### FIELD

The disclosure relates to a filling system, and more particularly to an automatic filling system.

### BACKGROUND

A conventional lotion filling system is for filling lotion or toner into a plurality of cosmetic containers. Each of the cosmetic containers has a feed opening. The conventional lotion filling system includes a straight assembly line unit that extends in a lengthwise direction, and that includes a plurality of transport seats movable in the lengthwise direction and spaced apart from one another in the lengthwise direction. The conventional lotion filling system further includes an input unit, a fill unit, a stopper placement unit, a cap placement unit, and an output unit that are disposed on the assembly line unit along the lengthwise direction.

The input unit is disposed at an end of the assembly line unit, and is for transferring the cosmetic containers, each of which has the feed opening facing upward, onto one of the transport seats. The fill unit is for filling the lotion or toner into the cosmetic containers in the one of the transport seats. The stopper placement unit is for inserting a plurality of stoppers into the feed openings of the cosmetic containers, respectively. The cap placement unit is for placing a plurality of caps onto the cosmetic containers, respectively. The output unit is disposed at an opposite end of the assembly line unit which is opposite to the input unit, and is for transferring the cosmetic containers, which are filled with the lotion, out of the assembly line unit.

Since the feed openings of the cosmetic containers face upward, dust may fall into the cosmetic containers and affect the quality of the lotion therein. Moreover, since the assembly line unit extends in a straight line, a relatively large space is occupied thereby, and operators are required at stations near the input and output units for ensuring smoothness of the filling operation, thus utilization of manpower may not be the most effective.

### SUMMARY

Therefore, an object of the disclosure is to provide an automatic filling system that can alleviate at least one of the drawbacks of the prior art.

According to the disclosure, the automatic filling system is for filling a filling material into at least one filling container which has a feed opening. The automatic filling system includes a base, a transport unit, an input unit, an inverting unit, a fill unit, a stopper placement unit, a cap placement unit, a locking unit, a detecting unit, a defect removing unit, and an output unit.

The transport unit includes a plurality of spaced-apart transport seats that are disposed on the base along a looped transport route and that are movable along the transport route relative to the base. Each of the transport seats has at least one insert hole adapted for insertion of the at least one filling container.

The input unit includes a first tray that is disposed on the base and that is adapted for receiving the at least one filling container with the feed opening facing downward, and a first transfer module that is operable to transfer the at least one filling container from the first tray into the at least one insert hole of an adjacent one of the transport seats.

The inverting unit is disposed along the transport route downstream of the input unit, and is operable to invert the at least one filling container which is in the adjacent one of the transport seats so that the feed opening faces upward.

The fill unit is disposed along the transport route downstream of the inverting unit, and is operable to fill the filling material into the at least one filling container.

The stopper placement unit is disposed along the transport route downstream of the fill unit, and includes a second tray that is adapted for receiving at least one stopper, and a second transfer module that is operable to transfer the at least one stopper from the second tray into the feed opening of the at least one filling container.

The cap placement unit is disposed along the transport route downstream of the stopper placement unit, and includes a third tray that is adapted for receiving at least one cap, and a third transfer module that is operable to transfer the at least one cap from the third tray onto the at least one filling container.

The locking unit is disposed along the transport route downstream of the cap placement unit, and is operable to lock the at least one cap on the at least one filling container.

The detecting unit is disposed along the transport route downstream of the locking unit, and includes a weight measuring module that is disposed on the base, and a fourth transfer module that is operable to transfer the at least one filling container in the adjacent one of the transport seats to the weight measuring module for weight measurement, and that is operable to transfer the at least one filling container back to the transport unit after weight measurement.

The defect removing unit is disposed along the transport route downstream of the detecting unit, and includes a fifth transfer module that is operable to remove the at least one filling container when a weight of the at least one filling container measured by the weight measuring module is out of a range pre-set in the weight measuring module.

The output unit is disposed along the transport route downstream of the defect removing unit and adjacent to the input unit, and includes an output tray that is disposed on the base, and a sixth transfer module that is operable to transfer the at least one filling container from the transport unit to the output tray.

### BRIEF DESCRIPTION OF THE DRAWINGS

Other features and advantages of the disclosure will become apparent in the following detailed description of the embodiment with reference to the accompanying drawings, of which:

FIG. 1 is a perspective view illustrating an embodiment of an automatic filling system according to the disclosure;

FIG. 2 is a top view of the embodiment;

FIG. 3 is a fragmentary perspective view of the embodiment;

FIG. 4 is another fragmentary perspective view of the embodiment;

FIG. 5 is yet another fragmentary perspective view of the embodiment; and

FIG. 6 is still another fragmentary perspective view of the embodiment.

### DETAILED DESCRIPTION

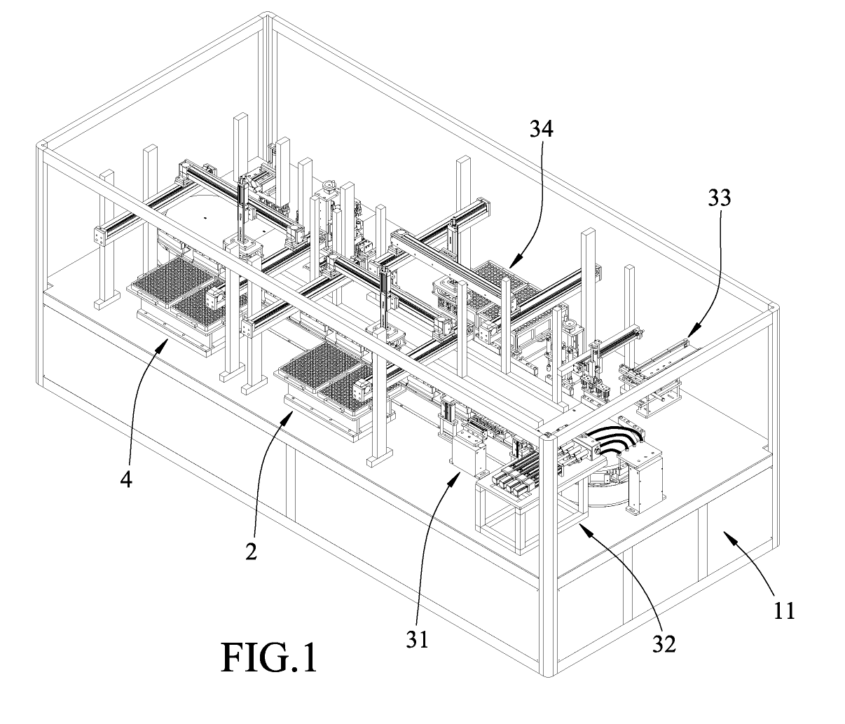

Referring to FIGS. 1 to 3, an embodiment of an automatic filling system is for filling a filling material (not shown) into a plurality of filling containers 7. Each of the filling containers 7 has a feed opening 71. In this embodiment, the filling containers 7 are cosmetic containers, and the filling material is, but not limited to be, lotion or toner. The filling material may be in powder form in other embodiments.

The automatic filling system includes a base 11, a transport unit 12, an input unit 2, an inverting unit 31, a fill unit 32, a stopper placement unit 33, a cap placement unit 34, a locking unit 35, a detecting unit 36, a defect removing unit 37, an output unit 4, a cap-positioning unit 51, a first positioning unit 52, a second positioning unit 53, and a stopper-positioning unit 54.

The transport unit 12 includes a plurality of spaced-apart transport seats 121 that are disposed on the base 11 along a looped transport route (S) and that are movable along the transport route (S) relative to the base 11. In this embodiment, each of the transport seats 121 has four insert holes 122 adapted for insertion of four of the filling containers 7, respectively. In other embodiments, the number of the insert holes 122 and the filling containers 7 may change based on actual design and production requirements. In this embodiment, a portion of the transport route (S) which corresponds in position to the input unit 2 is straight.

The input unit 2 includes a first tray 21 that is disposed on the base 11 and that is adapted for receiving the filling containers 7 with the feed openings 71 facing downward, and a first transfer module 22 that is operable to transfer four of the filling containers 7 from the first tray 21 into the insert holes 122 of an adjacent one of the transport seats 121. The first transfer module 22 includes two first rails 221, a second rail 222, a slide rail 223, and a clamp pawl mechanism 224. The first rails 221 are perpendicular to the straight portion of the transport route (S), and are respectively disposed at opposite sides of the first tray 21. The second rail 222 spans over the first rails 221 and is movable along the first rails 221. The slide rail 223 extends in an up-down direction (Z) which is perpendicular to the transport route (S), and is disposed on and movable along the second rail 222. The clamp pawl mechanism 224 is connected to the slide rail 22, is movable in the up-down direction (Z) along the slide rail 223 relative to the second rail 222, and is operable to clamp the four filling containers 7 with the feed openings 71 facing downward.

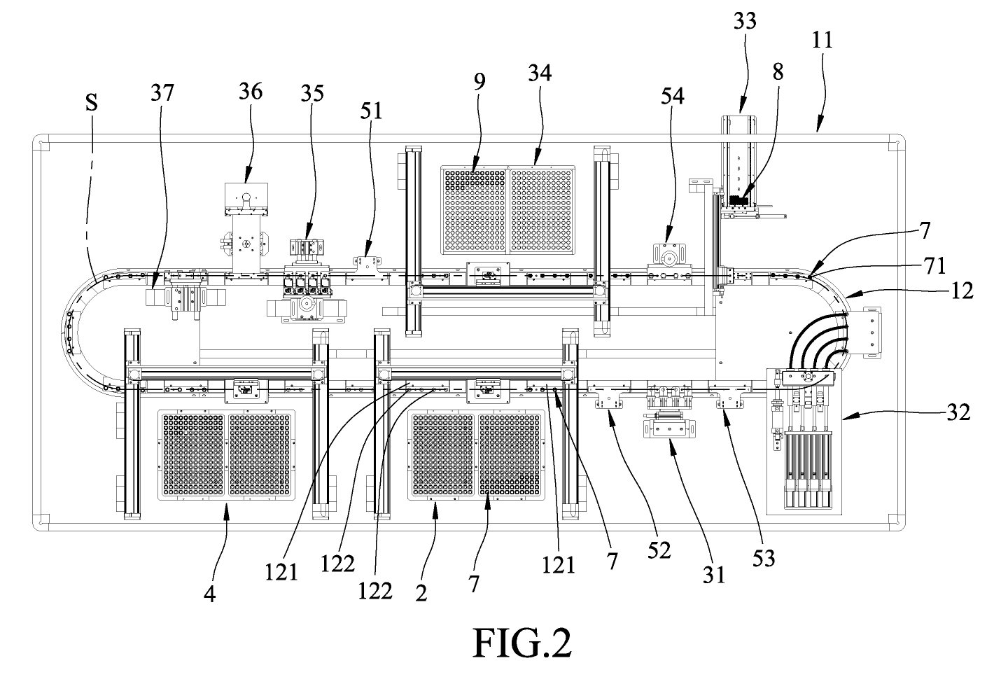

Referring to FIGS. 2 to 4, the inverting unit 31 is disposed along the transport route (S) downstream of the input unit 2, and is operable to invert the four filling containers 7 which are in the adjacent one of the transport seats 121 so that the feed openings 71 face upward.

In greater detail, the inverting unit 31 includes a movable module 311 that is movable relative to the base 11 along the up-down direction (Z), a rotatable module 312 that is mounted to the movable module 311 and that is rotatable about an axis (L) which is perpendicular to the up-down direction (Z), and four holder modules 313 that are co-rotatably connected to the rotatable module 312 and that are operable to respectively hold the four filling containers 7 in the adjacent one of the transport seats 121. In this embodiment, the axis (L) is transverse to the portion of the transport route (S) which corresponds in position to the input unit 2.

The fill unit 32 is disposed along the transport route (S) downstream of the inverting unit 31, and is operable to fill the filling material into the four filling containers 7.

The stopper placement unit 33 is disposed along the transport route (S) downstream of the fill unit 32, and includes a second tray 331 that is adapted for receiving a plurality of stoppers 8, and a second transfer module 332 that is operable to transfer four of the stoppers 8 from the second tray 331 and respectively insert the four stoppers 8 into the feed openings 71 of the four filling containers 7.

Referring to FIGS. 2, 4, and 5, the cap placement unit 34 is disposed along the transport route (S) downstream of the stopper placement unit 33, and includes a third tray 341 that is adapted for receiving a plurality of caps 9, and a third transfer module 342 that is operable to transfer four of the caps 9 from the third tray 341 and respectively place the four caps 9 onto the four filling containers 7.

The locking unit 35 is disposed along the transport route (S) downstream of the cap placement unit 34, and is operable to lock the caps 9 on the four filling containers 7, respectively. More specifically, the locking unit 35 locks the caps 9 onto the filling containers 7 by first screw loosening and then screw tightening the caps 9 so as to prevent titling of the caps 9 with respect to the filling containers 7.

The detecting unit 36 is disposed along the transport route (S) downstream of the locking unit 35, and includes a weight measuring module 361 that is disposed on the base 11, and a fourth transfer module 362 that is operable to transfer the four filling containers 7 in the adjacent one of the transport seats 121 to the weight measuring module 361 for weight measurement, and that is operable to transfer the four filling containers 7 back to the transport unit 12 after weight measurement.

The defect removing unit 37 is disposed along the transport route (S) downstream of the detecting unit 36, and includes a fifth transfer module 371 that is operable to remove the filling container(s) 371 when a weight of any of the four filling containers 7 measured by the weight measuring module 361 is out of a range pre-set in the weight measuring module 361.

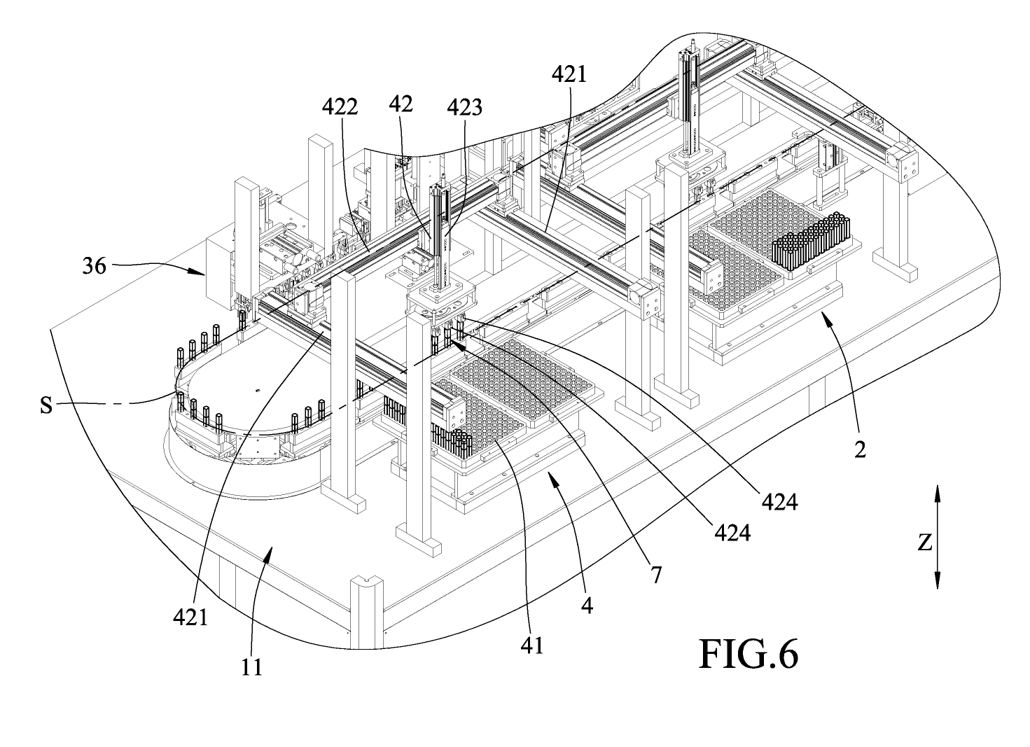

Referring to FIGS. 2, 5, and 6, the output unit 4 is disposed along the transport route (S) downstream of the defect removing unit 37 and adjacent to the input unit 2, and includes an output tray 41 that is disposed on the base 11, and a sixth transfer module 42 that is operable to transfer the four filling containers 7 from the transport unit 12 to the output tray 41.

A portion of the transport route (S) which corresponds in position to the output unit 4 is also straight. The sixth transfer module 42 of the output unit 4 includes two first rails 421, a second rail 422, a slide rail 423, and a clamp pawl mechanism 424. The first rails 421 are perpendicular to the straight portion of the transport route (S), and are respectively disposed at opposite sides of the output tray 41. The second rail 422 spans over the first rails 421 and is movable along the first rails 421. The slide rail 423 extends in the up-down direction (Z), is disposed on and movable along the second rail 422, and is movable in the up-down direction (Z) relative to the second rail 422. The clamp pawl mechanism 424 is connected to the slide rail 423, is movable in the up-down direction (Z) along the slide rail 423 relative to the second rail 422, and is operable to clamp the four filling containers 7.

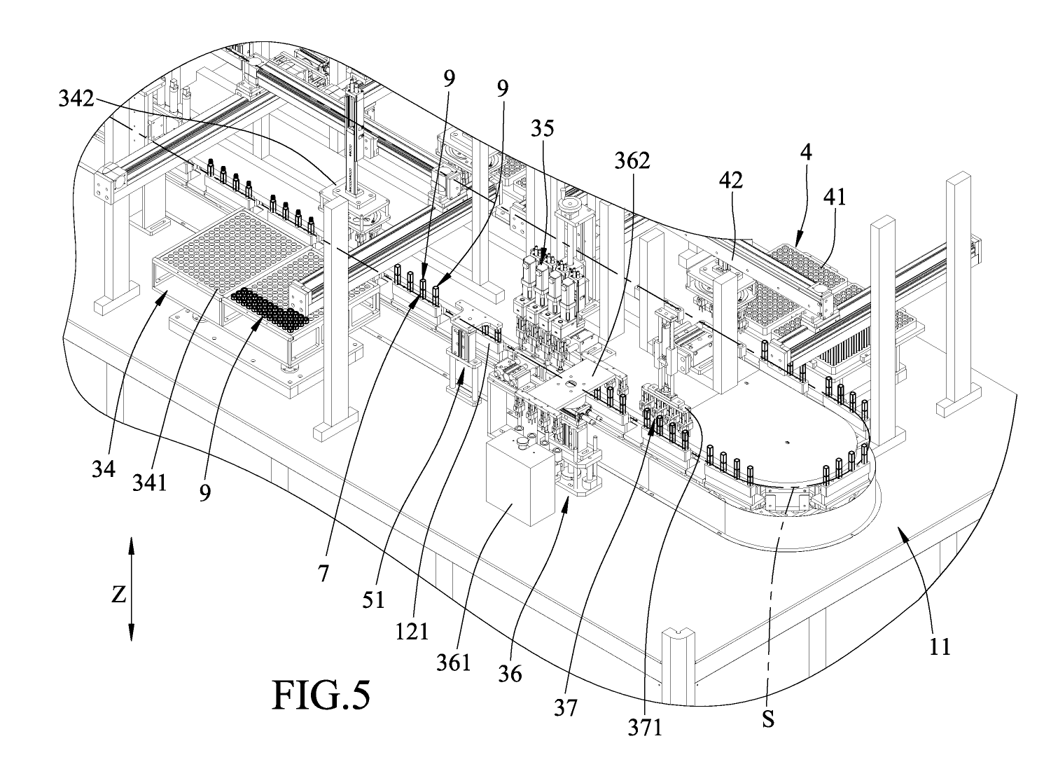

Referring to FIGS. 2 and 5, the cap-positioning unit 51 is disposed along the transport route (S) downstream of the cap placement unit 34 and upstream of the locking unit 35, and is operable to position the caps 9 on the filling containers 7 by pressing the caps 9 in the up-down direction (Z) after placement of the caps 9 onto the four filling containers 7. More specifically, the cap-positioning unit 51 presses the caps 9 downward so as to securely position the caps 9 onto the four filling containers 7, and then is lifted up away from the four filling containers 7.

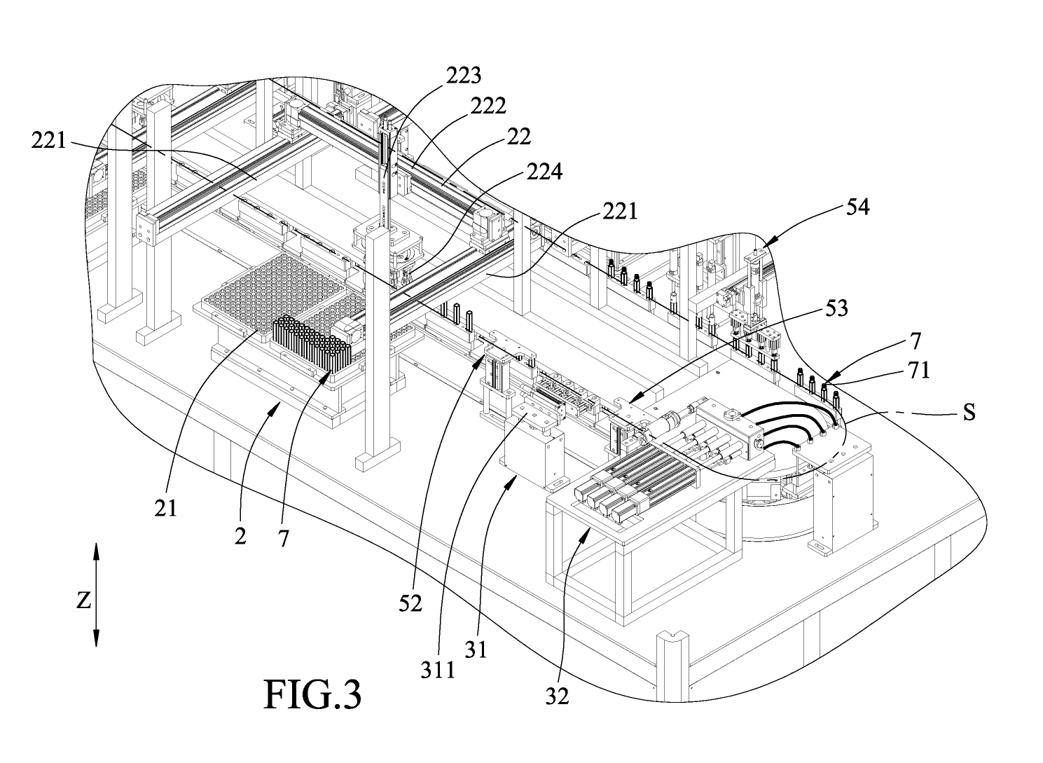

Referring to FIGS. 2 and 3, the first positioning unit 52 is disposed along the transport route (S) downstream of the input unit 2 and upstream of the inverting unit 31, and is operable to position the four filling containers 7, the feed openings 71 of which face downward, in the insert holes 122 of the adjacent one of the transport seats 121 by pressing the filling containers 7 in the up-down direction (Z). More specifically, the first positioning unit 52 presses the four filling containers 7 downward so as to securely position the four filling containers 7 in the respective insert holes 122, and then is lifted up away from the four filling containers 7.

The second positioning unit 53 is disposed along the transport route (S) downstream of the inverting unit 31 and upstream of the fill unit 32, and is operable to position the four filling containers 7, the feeding openings of which face upward, in the insert holes 122 of the adjacent one of the transport seats 121 by pressing the four filling containers 7 in the up-down direction (Z). More specifically, the second positioning unit 53 presses the four filling containers 7 downward so as to securely position the four filling containers 7 in the respective insert holes 122, and then is lifted up away from the four filling containers 7.

Referring to FIGS. 2 to 4, the stopper-positioning unit 54 is disposed along the transport route (S) downstream of the stopper placement unit 33 and upstream of the cap placement unit 34, is operable to secure the stoppers 8 onto the four filling containers 7 by pressing the stoppers 8 in the up-down direction (Z) after placement of the stoppers 8 onto the four filling containers 7. More specifically, the stopper-positioning unit 54 presses the stoppers 8 downward so as to securely position the stoppers 8 in the respective feed openings 71 of the four filling containers 7, and then is lifted up away from the four filling containers 7. In this way, the stopper-positioning unit 54 can be used for determining whether or not each of the stoppers 8 is properly inserted into a respective one of the feed openings 71 of the filling containers 7, so that the filling container 7 without the stopper 8 inserted therein can be removed by the defect removing unit 37.

The succeeding paragraphs describe a filling operation exemplified using four of the filling containers 7 to be filled with the filling material. The filling containers 7 are first transferred to one of the transport seats 121 by the first transfer module 22 with the feed openings 71 facing downward, and the transport seat 121 is moved to a position corresponding to the first positioning unit 52 so that the first positioning unit 52 is operated to respectively and securely position the filling containers 7 in the insert holes 122 of the transport seat 121. Next, the transport seat 121 is moved to a position corresponding to the inverting unit 31, and the movable module 311 of the inverting unit 31 is operated to move the holder modules 313 toward the transport seat 121 for the holder modules 313 to respectively hold the filling containers 7, and then the movable module 311 moves the holder modules 313 upward so as to permit separation of the filling containers 7 from the insert holes 122 of the transport seat 121. Subsequently, the rotatable module 312 is operated to rotate about the axis (L) such that the filling containers 7 are inverted with the feed openings 71 facing upward. Afterwards, the movable module 311 moves the holder modules 313 downward, and the holder modules 313 release the filling containers 7 so that the filling containers 7 are respectively inserted back into the insert holes 122 of the transport seat 121, and then the transport seat 121 is moved to a position corresponding to the second positioning unit 53 for secure positioning of the filling containers 7 in the respective insert holes 122.

Afterwards, the transport seat 121 is moved to a position corresponding to the fill unit 32, and the fill unit 32 fills the filling material into the filling containers 7 through the feed openings 71. The transport seat 121 is then moved to a position corresponding to the stopper placement unit 33, and the second transfer module 332 of the stopper placement unit 33 is operated to transfer four of the stoppers 8 from the second tray 331 into the respective feed openings 71 of the filling containers 7, followed by moving the transport seat 121 to a position corresponding to the stopper-positioning unit 54 for secure positioning of the stoppers 8 in the respective feed openings 71.

After insertion of the stoppers 8, the transport seat 121 is moved to a position corresponding to the cap placement unit 34, and the third transfer module 342 of the cap placement unit 34 transfers four of the caps 9 from the third tray 341 onto the filling containers 7, respectively. Next, the transport seat 121 is moved to a position corresponding to the cap-positioning unit 51 for secure positioning of the caps 9 onto the filling containers 7. The transport seat 121 is then moved to a position corresponding to the locking unit 35 for locking/tightening of the caps 9 on the filling containers 7.

Referring to FIGS. 2, 3, and 5, subsequently, the transport seat 121 is moved to a position corresponding to the detecting unit 36, and the fourth transfer module 362 of the detecting unit 36 transfers the filling containers 7 to the weight measuring module 361 for weight measurement. In this embodiment, the fourth transfer module 362 transfers the filling containers 7 to another one of the transport seats 121 which is upstream of the one of the transport seats 121 along the transport route (S) after the weight measurement by the weight measuring module 361. In this way, time is saved since the filling containers 7 are not transferred back to the one of the transport seats 121, which allows for continuous movement and subsequent operations of the transport seats 121 during movement of the fourth transfer module 362 between the weight measuring module 361 and the transport seats 121.

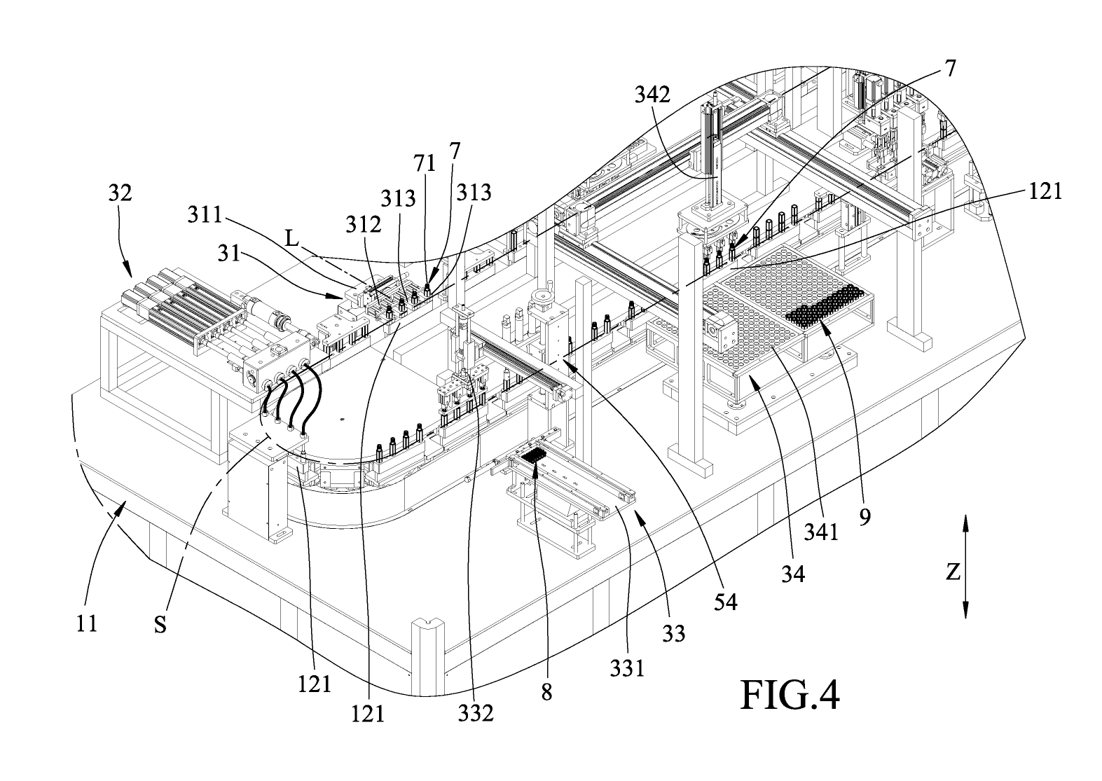

Referring to FIGS. 4 to 6, afterwards, the transport seat 121 is moved to a position corresponding to the defect removing unit 37, so as to allow the fifth transfer module 371 of the defect removing unit 37 to remove any one of the filling containers 7 which has a weight out of the range pre-set in said weight measuring module 361, and any one of the filling containers 7 without the stopper 8 therein from the another one of the transport seats 121. Finally, the another one of the transport seats 121 is moved to a position corresponding to the output unit 4, and the sixth transfer module 42 of the output unit 4 transfers the filling containers 7 to the output tray 41. At this time, the transport seat 121 is ready for the next filling operation.

Referring to FIG. 4, it is worth mentioning that the caps 9 will not be placed on the filling containers 7 by the cap placement unit 34 when the filling containers 7 are detected without the stoppers 8 already inserted therein.

Referring to FIG. 3, since the filling containers 7 in the first tray 21 are positioned with the feed openings 71 facing downward, dust is effectively prevented from falling into the filling containers 7 before the filling operation.

Furthermore, as shown in FIGS. 2 and 3, by virtue of the configuration of the looped transport route (S), the input unit 2 and the output unit 4 are adjacent to each other, so that operator(s) stationed near the input unit 2 and the output unit 4 can ensure smoothness in operation for both the input unit 2 and the output unit 4. Thus, fewer operators are required, and smaller space is occupied compared to the above-mentioned conventional lotion filling system.

It should be noted that the number of the filling containers 7, the stoppers 8, the caps 9, and the insert holes 122 of each of the transport seats 121 is more than one in this embodiment. In other embodiments, the number of the filling containers 7, the stoppers 8, the caps 9, and the insert holes 122 of each of the transport seats 121 may be one.

In summary, the design and incorporation of the inverting unit 31 in the automatic filling system effectively prevent dust from falling into the filling containers 7 before being inverted by the inverting unit 31, and the configuration of the looped transport route (S) enables effective utilization of manpower during the filling operation. It is also worth mentioning that the filling containers 7 can be manufactured by injection molding, and the succeeding manufacturing process(es), for example, label printing, may be performed with the feed openings 71 of the filling containers 7 facing downward. In this way, dust is effectively prevented from falling into the filling containers 7 before the filling operation begins.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. An automatic filling system for filling a filling material into at least one filling container which has a feed opening, said automatic filling system comprising:
a base;
a transport unit including a plurality of spaced-apart transport seats that are disposed on said base along a looped transport route and that are movable along said transport route relative to said base, each of said transport seats having at least one insert hole adapted for insertion of the at least one filling container;
an input unit including a first tray that is disposed on said base and that is adapted for receiving the at least one filling container with the feed opening facing downward, and a first transfer module that is operable to transfer the at least one filling container from said first tray into said at least one insert hole of an adjacent one of said transport seats;
an inverting unit disposed along said transport route downstream of said input unit, and being operable to invert the at least one filling container which is in said adjacent one of said transport seats so that the feed opening faces upward;
a fill unit disposed along said transport route downstream of said inverting unit, and being operable to fill the filling material into the at least one filling container;
a stopper placement unit disposed along said transport route downstream of said fill unit, and including a second tray that is adapted for receiving at least one stopper, and a second transfer module that is operable to transfer the at least one stopper from said second tray into the feed opening of the at least one filling container;
a cap placement unit disposed along said transport route downstream of said stopper placement unit, and including a third tray that is adapted for receiving at least one cap, and a third transfer module that is operable to transfer the at least one cap from said third tray onto the at least one filling container;
a locking unit disposed along said transport route downstream of said cap placement unit, and being operable to lock the at least one cap on the at least one filling container;
a detecting unit disposed along said transport route downstream of said locking unit, and including a weight measuring module that is disposed on said base, and a fourth transfer module that is operable to transfer the at least one filling container in said adjacent one of said transport seats to said weight measuring module for weight measurement and that is operable to transfer the at least one filling container back to said transport unit after weight measurement;
a defect removing unit disposed along said transport route downstream of said detecting unit, and including a fifth transfer module that is operable to remove the at least one filling container when a weight of the at least one filling container measured by said weight measuring module is out of a range pre-set in said weight measuring module; and
an output unit disposed along said transport route downstream of said defect removing unit and adjacent to said input unit, and including an output tray that is disposed on said base, and a sixth transfer module that is operable to transfer the at least one filling container from said transport unit to said output tray.

2. The automatic filling system as claimed in claim 1, adapted for filling the filling material into a plurality of the filling containers each having the feed opening, wherein:
each of said transport seats has a plurality of said insert holes for receiving part of the filling containers, respectively;
said second tray is adapted for receiving a plurality of the stoppers, and said second transfer module is operable to transfer part of the stoppers from said second tray and respectively insert the stoppers into the feed openings of the filling containers which are in said adjacent one of said transport seats; and
said third tray is adapted for receiving a plurality of the caps, and said third transfer module is adapted to transfer part of the caps from said third tray and respectively place the caps onto the filling containers in said adjacent one of said transport seats.

3. The automatic filling system as claimed in claim 2, wherein said inverting unit includes a movable module that is movable relative to said base along an up-down direction which is perpendicular to the transport route, a rotatable module that is mounted to said movable module and that is rotatable about an axis which is perpendicular to the up-down direction, and a plurality of holder module that are co-rotatably connected to said rotatable module and that are operable to respectively hold the filling containers which are in said adjacent one of said transport seats.

4. The automatic filling system as claimed in claim 3, further comprising a cap-positioning unit disposed along the transport route downstream of said cap placement unit and upstream of said locking unit, and being operable to position the caps on the filling containers by pressing the caps in the up-down direction after placement of the caps onto the filling containers which are in said adjacent one of said transport seats.

5. The automatic filling system as claimed in claim 4, further comprising a first positioning unit disposed along the transport route downstream of said input unit and upstream of said inverting unit, and being operable to position the filling containers, the feed openings of which face downward, in said insert holes of said adjacent one of said transport seats by pressing the filling containers in the up-down direction.

6. The automatic filling system as claimed in claim 5, further comprising a second positioning unit disposed along the transport route downstream of said inverting unit and upstream of said fill unit, and being operable to position the filling containers, the feeding openings of which face upward, in said insert holes of said adjacent one of said transport seats by pressing the filling containers in the up-down direction.

7. The automatic filling system as claimed in claim 6, wherein said locking unit locks the caps onto the filling containers which are in said adjacent one of said transport seats by first screw loosening and then screw tightening the caps so as to prevent titling of the caps with respect to the filling containers.

8. The automatic filling system as claimed in claim 7, wherein a portion of the transport route which corresponds in position to said input unit is straight, said first transfer module of said input unit including
two first rails that are perpendicular to the portion of the transport route and that are respectively disposed at opposite sides of said first tray,
a second rail that spans over said first rails and that is movable along said first rails,
a slide rail that extends in the up-down direction, and that is disposed on and movable along said second rail, and
a clamp pawl mechanism that is connected to said slide rail, that is movable in the up-down direction relative to said second rail, and that is operable to clamp the filling containers.

9. The automatic filling system as claimed in claim 8, wherein a portion of the transport route which corresponds in position to said output unit is straight, said sixth transfer module of said output unit including
two first rails that are perpendicular to the portion of the transport route and that are respectively disposed at opposite sides of said output tray,
a second rail that spans over said first rails of said sixth transfer module and that is movable along said first rails of said sixth transfer module,
a slide rail that extends in the up-down direction, that is disposed in and movable along said second rail of said sixth transfer module, and that is movable in the up-down direction relative to said second rail of said sixth transfer module, and
a clamp pawl mechanism that is connected to said slide rail of said sixth transfer module, that is movable in the up-down direction relative to said second rail of said sixth transfer module, and that is operable to clamp the filling containers.

10. The automatic filling system as claimed in claim 8, further comprising a stopper-positioning unit disposed along the transport route downstream of said stopper placement unit and upstream of said cap placement unit, being operable to secure the stoppers onto the filling containers by pressing the stoppers in the up-down direction after placement of the stoppers onto the filling containers, and for determining whether or not each of the stoppers is properly inserted into a respective one of the feed openings of the filling containers.

11. The automatic filling system as claimed in claim 8, wherein the axis is transverse to the portion of the transport route.

12. The automatic filling system as claimed in claim 1, wherein said fourth transfer module of said detecting unit transfers the at least one filling container to another one of said transport seats which is upstream of said adjacent one of said transport seat along the transport route after the weight measurement by said weight measuring module.
